(19) United States
(12) Patent Application Publication
(10) Pub. No.: US 2018/0037718 A1
(43) Pub. Date: Feb. 8, 2018

(54) POLYAMIDE COMPOSITION WITH DELAYED COMBUSTIBILITY

(71) Applicant: Arkema France, Colombes (FR)

(72) Inventors: Marc AUDENAERT, Bernay (FR); Philippe BLONDEL, Bernay (FR); Jean-Jacques FLAT, Goupillieres (FR)

(73) Assignee: Arkema France, Colombes (FR)

(21) Appl. No.: 15/549,055

(22) PCT Filed: Feb. 5, 2016
(86) PCT No.: PCT/EP2016/052553

§ 371 Date: Aug. 4, 2017

(30) Foreign Application Priority Data
Feb. 5, 2015 (FR) 1550914

(51) Int. Cl. C08K 5/053; C08K 7/02; C08L 77/02; C08K 5/3492

(52) U.S. Cl. CPC C08K 5/053; C08K 5/3492; C08K 7/02; C08L 77/02; C08K 5/0025

(57) ABSTRACT

The invention relates to a composition which includes: at least one polyamide; at least one melamine derivative as a fire-retardant agent; optionally at least one polyol containing at least four alcohol functional groups; and optionally at least one reinforcement in the form of a fiber. The invention also relates to the method for producing said composition and to the use of same.

The present invention relates to a composition comprising at least one polyamide, at least one particular flame retardant, optionally at least one polyol and optionally at least one specific reinforcer, and also to a process for preparing said composition and to uses of said composition.

The use of materials such as polyamides has grown considerably in the last ten years. These materials often aim to replace parts initially made of metal, thus resulting in a considerable lightening of the article thus modified. Yet it has turned out that in certain fields these materials were only used a little, due to their excessively high flammability.

For example, in the transport field, and more particularly the aviation field, the requisite standards in terms of flammability are extreme. The airworthiness regulations impose specific flammability tests. Specifically, materials that are too readily flammable cannot be tolerated within a vehicle such as an aircraft.

Furthermore, it is also sought, in particular in the transport field, to lighten the structures as much as possible, even those that are already made of plastic materials. Specifically, it is sought to lighten the structures in order to reduce the fuel consumption costs and to limit the carbon footprint linked to the consumption of these fuels.

Consequently, there is a real need to propose polyamide-based compositions that have improved properties in terms of flammability, weight, and ease of processing.

For the purpose of improving the flame retardant properties of plastic materials, much research has been carried out.

Some has focused on the development of new additives: flame retardants to be incorporated into the material. Thus, ranges of non-halogenated agents derived from phosphorus, phosphinates, have been developed without however leading to results that are actually satisfactory.

This research led to the composition disclosed in document EP 0 169 085. The latter discloses a specific combination of flame retardant compounds: melamine cyanurate and a polyol.

The applicant continued its studies in this particular field and found that the composition according to the invention led to unexpected results in terms of combustion delay.

Other features, aspects, subjects and advantages of the present invention will emerge even more clearly on reading the description and the examples that follow.

A subject of the present invention is thus firstly a composition comprising:
at least one polyamide,
at least one melamine derivative as flame retardant,
optionally at least one polyol comprising at least four alcohol functions, and
optionally at least one reinforcer in fiber form.

The invention also relates to a process for preparing such a composition.

The invention relates to a use of the composition, in particular in the electrical, electronic and avionics fields.

A final subject of the invention is an article obtained from this composition.

Polyamide

In general, the polyamides used in the composition according to the invention are semicrystalline or amorphous, obtained in particular by anionic polycondensation and comprising at least two identical or different repeating units, these units possibly being formed from a dicarboxylic acid and a diamine; an amino acid; a lactam or mixtures thereof.

The polyamide according to the invention may be a homopolyamide and may comprise at least two identical repeating units obtained from an amino acid, obtained from a lactam, or corresponding to the formula (Ca diamine).(Cb diacid), with a representing the number of carbon atoms in the diamine and b representing the number of carbon atoms in the diacid, a and b each being between 4 and 36, as defined hereinbelow.

The polyamide according to the invention may also be a copolyamide and may comprise at least two different repeating units, these units possibly being obtained from an amino acid, obtained from a lactam or corresponding to the formula (Ca diamine).(Cb diacid), with a representing the number of carbon atoms in the diamine and b representing the number of carbon atoms in the diacid, a and b each being between 4 and 36, as defined hereinbelow.

The (Ca diamine).(Cb diacid) units may be aliphatic and linear, cycloaliphatic or aromatic.

The polyamide according to the invention may comprise at least one amino acid selected from 9-aminononanoic acid, 10-aminodecanoic acid, 12-aminododecanoic acid and 11-aminoundecanoic acid, and derivatives thereof, especially N-heptyl-11-aminoundecanoic acid.

The polyamide according to the invention may comprise at least one lactam selected from pyrrolidinone, piperidinone, caprolactam, enantholactam, caprylolactam, pelargolactam, decanolactam, undecanolactam and laurolactam.

The polyamide according to the invention may comprise at least one unit corresponding to the formula (Ca diamine).(Cb diacid), the (Ca diamine) unit is of formula H₂N—(CH₂)ₐ—NH₂, when the diamine is aliphatic and linear.

Preferentially, when the Ca diamine is linear and aliphatic, it is selected from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22) and diamines obtained from fatty acids.

When the diamine is cycloaliphatic, it is preferably selected from those comprising two rings. They especially correspond to the following general formula:

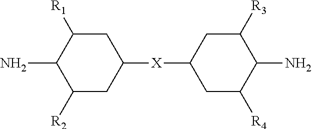

in which:

R₁, R₂, R₃ and R₄ represent identical or different groups selected from a hydrogen atom or alkyl groups having from 1 to 6 carbon atoms and X represents either a single bond or a divalent group formed:
from a linear or branched aliphatic chain comprising from 1 to 10 carbon atoms, optionally substituted by cycloaliphatic or aromatic groups having from 6 to 8 carbon atoms,
from a cycloaliphatic group having from 6 to 12 carbon atoms.

More preferentially, the cycloaliphatic diamine of the polyamide according to the invention is selected from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis-(3-methyl-4-aminocyclohexyl)methane (noted BMACM, MACM or B), p-bis(aminocyclohexyl)methane (PACM) and isopropylidenedi(cyclohexylamine) (PACP).

A nonexhaustive list of these cycloaliphatic diamines is given in the publication “Cycloaliphatic Amines” (Encyclopedia of Chemical Technology, Kirk-Othmer, 4th Edition (1992), pp. 386-405).

Preferably, when the diamine is alkylaromatic, it is selected from 1,3-xylylenediamine, 1,4-xylylenediamine and a mixture thereof.

Preferably, when the (Cb diacid) monomer is aliphatic and linear, it is selected from succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanoic acid (b=18), octadecenedioic acid (b=18), eicosanedioic acid (b=20), docosanedioic acid (b=22) and fatty acid dimers containing 36 carbons.

Preferably, when the (Cb diacid) monomer is aromatic, it is selected from terephthalic acid, noted T, and isophthalic acid, noted I, and naphthalene diacid.

The fatty acid dimers mentioned above are dimerized fatty acids obtained by oligomerization or polymerization of unsaturated monobasic fatty acids bearing a long hydrocarbon chain (such as linoleic acid and oleic acid), as described in particular in document EP 0 471 566.

When the diacid is cycloaliphatic, it may comprise the following carbon backbones: norbornylmethane, cyclohexylmethane, dicyclohexylmethane, dicyclohexylpropane, di(methylcyclohexyl)propane.

If, with the exception of N-heptyl-11-aminoundecanoic acid, the fatty acid dimers and the cycloaliphatic diamines, the comonomers or starting materials envisaged in the present description (amino acids, diamines, diacids) are effectively linear, there is nothing to stop it from being envisaged that they may be wholly or partially branched, such as 2-methyl-1,5-diaminopentane, or partially unsaturated.

It will be noted in particular that the C18 dicarboxylic acid may be octadecanedioic acid, which is saturated, or else octadecenedioic acid, which itself contains an unsaturation.

Preferably, the polyamide according to the invention has a number of carbon atoms per nitrogen atom of greater than 8.

Preferably, the homopolyamide may be selected from a homopolyamide PA 6.10 obtained by polycondensation of hexanediamine and decanedioic acid, PA B.12 also noted BMACM.12 obtained by polycondensation of bis(3-methyl-4-aminocyclohexyl)methane and dodecanedioic acid, PA 10.12 obtained by polycondensation of decanediamine and dodecanedioic acid, PA 10.10 obtained by polycondensation of decanediamine and decanedioic acid, PA 6.12 obtained by polycondensation of hexanediamine and decanedioic acid, the homopolyamide PA11 obtained by polycondensation of 11-aminoundecanoic acid and the homopolyamide PA12 obtained by polycondensation of 12-aminododecanoic acid or lauryllactam.

Preferably, the copolyamide may be selected from the following copolyamides: PA11/6.T, PA11/10.T, PA11/B.10, PA11/6, PA11/6.10, PA11/6.12, PA11/6.6, PA11/10.12, PA11/B.I/B.T.

Preferentially, the polyamide may be selected from PA11, PA12, PA 10.10, PA 10.12, PA 6.10, PA11/10.T and PA11/B.10.

The nomenclature used to define polyamides is described in the standard ISO 1874-1:1992 “Plastics—Polyamide (PA) moulding and extrusion materials—Part 1: Designation”, in particular on page 3 (tables 1 and 2), and is well known to a person skilled in the art.

The composition according to the invention comprises from 20% to 80% by weight and preferably from 30% to 70% by weight, relative to the total weight of the composition, of at least one semicrystalline or amorphous polyamide.

The composition according to the invention may also comprise one or more semicrystalline or amorphous homopolyamides or copolyamides, or a mixture thereof.

The polyamides according to the invention may be used in the form of granules or in powder form.

Viscosity

Preferably, the polyamide has a melt viscosity of between 1 and 500 Pa·s, in particular between 10 and 500 Pa·s measured at 240° C. by plate-plate oscillatory rheology at a shear of 100 s⁻¹. The measurement method followed for carrying out this measurement is the following:

The tests are carried out on μDSM equipped with screws 111 and 123 (profile 2 screw).

The flat temperature profile at 240° C. is programmed. The various mixtures are produced with a screw speed of 100 rpm and a recirculation time of 25 minutes, to which the machine feed time, i.e. between 1′30 and 2′, has to be added. The tests are carried out while flushing with nitrogen (0.5 bar).

The normal force is measured in N. It represents the change in the melt viscosity. The viscosity at TO and its change at T+30 minutes are determined by plate-plate oscillatory rheology.

Plate-plate: 30 min at 240° C. 10 rad/sec 5% deformation according to the following operating conditions:

Device: PHYSICA MCR301

Geometry: parallel plates with a diameter of 25 mm

Temperatures: 240° C.

Frequency: 10 rad·s⁻¹

Duration: 30 minutes

Atmosphere: Flushing with nitrogen.

Shear of 100 s⁻¹

Chain Termination

A homopolyamide or a copolyamide is terminated with an amine function and an acid function, when it is obtained by polycondensation of amino acids, by polycondensation of lactams or else by polycondensation of diacids and diamines. However, in the latter case, it is also possible to obtain two acid functions or else two amine functions.

According to the present invention, chain-terminating agents are compounds that are capable of reacting with the amine end functions of the polyamides, thus modifying the reactivity of the amine end of the macromolecule, and thus controlling the polycondensation of the polyamide and also the stability of the melt viscosity of the composition during its transformation.

The termination reaction may be illustrated, for example, in the following manner:

Polyamide-NH₂+R—CO₂H→Polyamide-NH—CO—R+H₂O

Thus, chain-terminating agents that are suitable for reacting with the amine end functions of the polyamide present in the composition according to the invention are monoacids or diacids, preferably comprising from 8 to 30 carbon atoms. The diacids may be selected from adipic acid, decanedioic acid and dodecanedioic acid. The monoacids may be selected from capric acid, acetic acid, benzoic acid, lauric acid, tridecylic acid, myristic acid, palmitic acid, stearic acid, pivalic acid and isobutyric acid.

Consequently, when the chain-terminating agent is a monoacid, the chain end group is an alkyl group, and when the chain-terminating agent is a diacid, the chain end group is an acid function.

Preferably, the chain limiters used during the preparation of the polyamide according to the invention are basic compounds, such as amines, or else carboxylic acid compounds, comprising less than 8 carbon atoms.

Preferably, the polyamide according to the invention is not a catalyzed polyamide. This means that it does not contain catalyst in its structure. The catalysts customarily used during the polycondensation thereof are acids derived from phosphorus. Thus, the polyamide according to the invention contains no acid derived from phosphorus, such as orthophosphoric acid or metaphosphoric acid or pyrophosphoric acid or phosphorous acid or hypophosphorous acid.

Chain Extender

The polyamide according to the invention may optionally comprise at least one chain extender block.

This chain extender block has the structure:

Y1-A′-Y1

with A′ being a hydrocarbon biradical of nonpolymeric structure (neither polymer nor oligomer nor prepolymer), bearing 2 identical end reactive functions Y1, which are reactive by polyaddition (without elimination of reaction by-product), with at least one chain-end function of the block copolymer according to the invention, preferably having a molecular weight of less than 500 and more preferably of less than 400,

in particular Y1 is selected from: oxazine, oxazoline, oxazolinone, oxazinone, imidazoline, epoxy, isocyanate, maleimide, cyclic anhydride.

As suitable examples of chain extenders, mention may be made of the following:
when the chain terminations are NH₂ or OH functions, preferably NH₂ functions, the chain extender Y1-A′-Y1 corresponds to:

Y1 selected from the following groups: maleimide, optionally blocked isocyanate, oxazinone and oxazolinone, cyclic anhydride, preferably oxazinone and oxazolinone, and

A′ is a carbon-based spacer or a carbon-based radical bearing the reactive groups or functions Y1, selected from:
a covalent bond between two functions (groups) Y in the case where Y1=oxazinone and oxazolinone or
an aliphatic hydrocarbon-based chain or an aromatic and/or cycloaliphatic hydrocarbon-based chain, the latter two comprising at least one optionally substituted ring of 5 or 6 carbon atoms, with optionally said aliphatic hydrocarbon-based chain optionally having a molecular weight of 14 to 200 g·mol⁻¹.

The chain extender Y1-A′-Y1 may also correspond to a structure in which

Y1 is a caprolactam group and

A′ is a carbonyl radical such as carbonyl biscaprolactam or A′ possibly being a terephthaloyl or an isophthaloyl.

The chain extender Y1-A′-Y1 may also bear a cyclic anhydride group

Y1 and preferably this extender is selected from a cycloaliphatic and/or aromatic carboxylic dianhydride and more preferentially it is selected from: ethylenetetracarboxylic dianhydride, pyromellitic dianhydride, 3,3′,4,4′-biphenyltetracarboxylic dianhydride, 1,4,5,8-naphthalenetetracarboxylic dianhydride, perylenetetracarboxylic dianhydride, 3,3′,4,4′-benzophenone tetracarboxylic dianhydride, 1,2,3,4-cyclobutanetetracarboxylic dianhydride, hexafluoroisopropylidene bisphthalic dianhydride, 9,9-bis(trifluoromethyl)xanthenetetracarboxylic dianhydride, 3,3′,4,4′-diphenylsulfonetetracarboxylic dianhydride, bicyclo[2.2.2]oct-7-ene-2,3,5,6-tetracarboxylic dianhydride, 1,2,3,4-cyclopentanetetracarboxylic dianhydride, 3,3′,4,4′-diphenyl ether tetracarboxylic dianhydride, or mixtures thereof and
when the chain terminations are COOH functions:

said chain extender Y1-A′-Y1 corresponds to:

Y1 selected from the groups: oxazoline, oxazine, imidazoline, aziridine, such as 1,1′-iso- or tere-phthaloyl bis(2-methylaziridine), or epoxy,

A′ being a carbon-based spacer (radical) as defined above.

More particularly, when, in said extender Y1-A′-Y1, said function Y1 is selected from oxazinone, oxazolinone, oxazine, oxazoline or imidazoline, in particular oxazoline, in this case, in the chain extender represented by Y1-A′-Y1, A′ may represent an alkylene such as —(CH₂)ₘ— with m ranging from 1 to 14 and preferably from 2 to 10, or A′ may represent a cycloalkylene and/or an arylene which is (alkyl-)substituted or unsubstituted, for instance benzenic arylenes, such as o-, m- or p-phenylenes, or naphthalenic arylenes, and preferably A′ is an arylene and/or a cycloalkylene.

In the case where Y1 is an epoxy, the chain extender can be selected from bisphenol A diglycidyl ether (BADGE), and its (cycloaliphatic) hydrogenated derivative bisphenol F diglycidyl ether, tetrabromo bisphenol A diglycidyl ether, or hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether having Mn<500, polypropylene glycol diglycidyl ether having Mn<500, polytetramethylene glycol diglycidyl ether having Mn<500, resorcinol diglycidyl ether, neopentylglycol diglycidyl ether, bisphenol A polyethylene glycol diglycidyl ether having Mn<500, bisphenol A polypropylene glycol diglycidyl ether having Mn<500, diglycidyl esters of dicarboxylic acid, such as terephthalic acid glycidyl ester, or epoxidized diolefins (dienes) or fatty acids with a double epoxidized ethylenic unsaturation, diglycidyl 1,2-cyclohexanedicarboxylate, and mixtures thereof.

In the case of carbonyl- or terephthaloyl- or isophthaloyl-biscaprolactam as chain extender Y1-A′-Y1, the preferred conditions avoid the elimination of by-product, such as caprolactam during said polymerization and processing in the molten state.

In the optional case mentioned above where Y1 represents a blocked isocyanate function, this blocking can be obtained using agents for blocking the isocyanate function, for instance epsilon-caprolactam, methyl ethyl ketoxime, dimethylpyrazole or diethyl malonate.

Likewise, in the case where the extender is a dianhydride which reacts with NH₂ functions derived from the block copolymer, the preferred conditions prevent any formation of an imide ring during the polymerization and during the processing in the molten state.

For OH or NH₂ terminations of the block copolymer, the group Y1 is preferably selected from: isocyanate (nonblocked), oxazinone and oxazolinone, more preferably oxazinone and oxazolinone, with, as spacer (radical), A′ being as defined above.

As examples of chain extenders bearing oxazoline or oxazine reactive functions Y that are suitable for the implementation of the invention, reference may be made to those described under references “A”, “B”, “C” and “D” on page 7 of application EP 0 581 642, and also to the processes for preparing same and the modes of reaction thereof which are disclosed therein. “A” in this document is bisoxazoline, “B” is bisoxazine, “C” is 1,3-phenylenebisoxazoline and “D” is 1,4-phenylenebisoxazoline.

By way of example, in the case where the CO₂H terminations of the block copolymer and the chain extender Y1-A′-Y1 are 1,4-phenylenebisoxazoline, the reaction product obtained has at least one repeating unit having the following structure:

—O—C(O)—P—C(O)—O—R₁—NH—C(O)-A′-C(O)—NH—R₁—

in which:

P is an acid-terminated polyamide HO—C(O)—P—C(O)—OH obtained from the amide units (A), (B) or (C),

R₁ is (CH₂)₂, and

A′ is a phenyl.

As examples of chain extenders with an imidazoline reactive function Y1 that are suitable for the implementation of the invention, reference may be made to those described (“A” to “F”) on pages 7 to 8 and table 1 on page 10 of application EP 0 739 924, and also to the processes for preparing same and the modes of reaction thereof which are disclosed therein.

As examples of chain extenders with a reactive function Y1=oxazinone or oxazolinone that are suitable for the implementation of the invention, reference may be made to those described under references “A” to “D” on pages 7 to 8 of application EP 0 581 641, and also to the processes for preparing same and the modes of reaction thereof which are disclosed therein.

As examples of oxazinone (6-atom ring) and oxazolinone (5-atom ring) groups Y1 that are suitable, mention may be made of the groups Y1 derived from: benzoxazinone of oxazinone or oxazolinone, with, as spacer, A′ possibly being a single covalent bond with respective corresponding extenders being: bis(benzoxazinone), bisoxazinone and bisoxazolinone.

A′ may also be a C1 to C14, preferably C2 to C10, alkylene, but preferably A′ is an arylene and more particularly it may be a phenylene (substituted with Y1 in positions 1,2 or 1,3 or 1,4) or a naphthalene radical (disubstituted with Y1) or a phthaloyl (iso- or terephthaloyl) or A′ may be a cycloalkylene.

For the functions Y1 such as oxazine (6-membered ring), oxazoline (5-membered ring) and imidazoline (5-membered ring), the radical A′ may be as described above with A′ possibly being a single covalent bond and with the respective corresponding extenders being: bisoxazine, bisoxazoline and bisimidazoline. A′ may also be a C1 to C14, preferably C2 to C10, alkylene. The radical A′ is preferably an arylene and more particularly it may be a phenylene (substituted with Y1 in positions 1,2 or 1,3 or 1,4) or a naphthalene radical (disubstituted with Y1) or a phthaloyl (iso- or terephthaloyl) or A′ may be a cycloalkylene.

In the case where Y1=aziridine (3-atom nitrogen-containing heterocycle equivalent to ethylene oxide with replacement of the ether —O— with —NH—), the radical A′ may be a phthaloyl (1,1-iso- or tere-phthaloyl) with, as an example of an extender of this type, 1,1′-isophtaloylbis(2-methylaziridine).

The presence of a catalyst of the reaction between the polyamide according to the invention and said extender Y1-A′-Y1 in a content ranging from 0.001% to 2%, preferably from 0.01% to 0.5%, relative to the total weight of two co-reactants mentioned, can accelerate the (poly)addition reaction and thus shorten the production cycle. Such a catalyst may be selected from: 4,4′-dimethylaminopyridine, p-toluenesulfonic acid, phosphoric acid, NaOH and optionally those described for a polycondensation or transesterification as described in EP 0 425 341, page 9, lines 1 to 7.

According to a more particular case of the choice of said extender, A′ may represent an alkylene, such as —(CH₂)ₘ— with m ranging from 1 to 14 and preferably from 2 to 10, or represents an alkyl-substituted or unsubstituted arylene, such as benzenic arylenes (such as o-, m- or p-phenylenes) or naphthalenic arylenes (with arylenes: naphthalenylenes). Preferably, A′ represents an arylene which may be a substituted or unsubstituted benzenic or naphthalenic arylene.

As already specified, said chain extender has a nonpolymeric structure and preferably a molecular weight of less than 500, more preferentially of less than 400.

Preferably, the polyamide according to the invention comprises at least one chain extender block located at one or more ends of the polyamide.

The content of said extender in said polyamide varies from 1% to 20%, in particular from 5% to 20%.

Melamine Derivatives

The composition according to the invention comprises at least one melamine derivative.

Melamine derivatives are understood, within the meaning of the present invention, to be compounds resulting from the action of melamine (1,3,5-triazine-2,4,6-triamine of empirical formula C₃H₆N₆) on the acid and, more particularly, the compound resulting from the equimolecular reaction of melamine with this acid.

The melamine derivatives may be selected from melamine cyanurate, melamine pyrophosphate and a mixture thereof.

Melamine cyanurate is understood to mean compounds resulting from the action of melamine on cyanuric acid and, more particularly, the compound resulting from the equimolecular reaction of melamine with cyanuric acid, whether this acid is in its enol or keto form.

Various companies sell such compounds under the name “melamine cyanurate”.

The composition according to the invention may comprise from 5% to 30% by weight, preferably from 10% to 30% by weight, and more preferentially from 10% and 20% by weight, relative to the total weight of the composition, of at least one melamine derivative.

Polyols

The composition according to the invention may comprise at least one polyol comprising at least four alcohol functions.

Polyols comprising at least four alcohol functions is understood to mean:
tetrols such as erythritol, monopentaerythritol (and its derivatives: dipentaerythritol and tripentaerythritol), etc.,
pentols such as xylitol, arabitol, etc.,
hexols such as mannitol, sorbitol, etc. and higher homologues.

It is of course possible to use said polyols alone or as a mixture.

Preferably, the polyol is selected from pentaerythritol, sorbitol, and a mixture thereof.

The composition according to the invention may comprise from 0.5% to 10% by weight and preferably from 1% to 5% by weight, relative to the total weight of the composition, of at least one polyol.

Preferably, the formulated polyamide represents at least 50% by weight of the total weight of the composition. Within the meaning of the present invention, formulated polyamide is understood to mean the composition according to the invention without the reinforcer(s).

Reinforcers

The composition according to the invention may comprise at least one reinforcer in fiber form.

The reinforcer according to the invention may be in the form of a continuous fiber, a long (optionally continuous) fiber or a short fiber.

A long fiber is understood according to the present invention to be a fiber having a length-to-diameter ratio of the fiber, which means that these fibers have a circular cross section, of greater than 1000, preferably of greater than 2000. In this assembly, the fibers may be continuous, in the form of a unidirectional (UD) or multidirectional (2D, 3D) reinforcer.

In particular, they may be in the form of fabrics, sheets, strips or braids and may also be cut, for example in the form of nonwovens (mats) or in the form of felts.

These fibers may, for example, be in the form of a reel, the continuous fiber then being impregnated with the composition (without the reinforcer), then granulated to the desired size. According to this embodiment, the fiber has the size of the granule and is indeed continuous over the whole of the granule.

Preferably, the “long” fibers have a length of between 0.10 and 250 mm and preferably of between 0.1 and 100 mm and in particular of between 0.1 and 5 mm.

Preferably, the “short” fibers have a length of between 200 and 400 μm.

Preferably, the reinforcer in continuous fiber form present in the composition according to the invention is selected from natural, polymeric or mineral fibers.

These reinforcing fibers may be selected from:
mineral fibers, said fibers having high melting temperatures Tm′ above the melting temperature Tm of said semicrystalline polyamide of the invention and above the polymerization and/or processing temperature;
polymeric fibers or polymer fibers having a melting temperature Tm′, or if not Tm′, a glass transition temperature Tg′, above the polymerization temperature or above the melting temperature Tm of said semicrystalline polyamide constituting said matrix of the composite and above the processing temperature;
or mixtures of the abovementioned fibers.

As mineral fibers suitable for the invention, mention may be made of carbon fibers, which include fibers of nanotubes or carbon nanotubes (CNTs), carbon nanofibers or graphenes; silica fibers such as glass fibers, in particular of E, R or S2 type; boron fibers; ceramic fibers, in particular silicon carbide fibers, boron carbide fibers, boron carbonitride fibers, silicon nitride fibers, boron nitride fibers, basalt fibers; fibers or filaments based on metals and/or alloys thereof; fibers of metal oxides, in particular of alumina (Al₂O₃); metallized fibers such as metallized glass fibers and metallized carbon fibers, or mixtures of the abovementioned fibers.

More particularly, the natural fibers are selected from flax, castor bean, wood, sisal, kenaf, coconut, hemp and jute fibers.

Preferably, the reinforcer present in the composition according to the invention is selected from glass fibers, carbon fibers, flax fibers and mixtures thereof, and more preferentially flax fibers and carbon fibers, and more preferentially still carbon fibers.

The composition according to the invention may comprise from 20% to 80% by weight, and preferably from 30% to 70% by weight, more particularly from 20% to 50% by weight and even more preferably from 30% to 45% by weight, relative to the total weight of the composition, of at least one reinforcer.

A coupler may be included therein to improve the adhesion of the fibers to the polyamide, such as silanes or titanates, which are known to those skilled in the art.

### PREFERRED EMBODIMENTS

According to a first preferred embodiment of the invention, the composition comprises:
at least one polyamide,
melamine cyanurate, and
pentaerythritol.

Preferably, this composition contains no reinforcer in fiber form.

According to a second preferred embodiment of the invention, the composition comprises:
at least one polyamide,
melamine cyanurate, and
at least one reinforcer in fiber form.

Preferably, this composition contains no polyol comprising at least four times the alcohol function.

According to a third preferred embodiment of the invention, the composition comprises:
at least one polyamide,
melamine cyanurate,
pentaerythritol, and
at least one reinforcer in fiber form.

Preferably, for each of these embodiments, the polyamide has a melt viscosity of between 1 and 500 Pa·s, in particular between 10 and 500 Pa·s measured at 240° C. by plate-plate oscillatory rheology and is selected from PA11, PA12, PA 10.10, PA 10.12, PA 6.10, PA11/10.T and PA11/B.10.

Preferably, the reinforcer is selected from glass fibers, carbon fibers and flax fibers.

The composition according to the invention may also comprise common additives for polyamides, such as: dyes, light (UV) stabilizers and/or heat stabilizers, plasticizers, impact modifiers, surfactants, pigments, optical brighteners, antioxidants, natural waxes, functional or non-functional crosslinked or non-crosslinked polyolefins, flame retardants other than those described above, such as a metal salt selected from a metal salt of phosphinic acid, a metal salt of diphosphinic acid, a polymer containing at least one metal salt of phosphinic acid, a polymer containing at least one metal salt of diphosphinic acid; mold-release agents or else fillers, and mixtures thereof.

The envisaged fillers include standard mineral fillers, such as those selected from the group, given in a non-limiting manner, comprising talc, kaolin, magnesia, slag, silica, carbon black, carbon nanotubes, expanded or non-expanded graphite, and titanium oxide.

Preferably, the additives of the composition according to the present invention may be present in an amount of less than or equal to 20% and preferably less than 10% by weight relative to the weight of the composition.

The invention also relates to a process for preparing a composition as defined above. According to this process, the composition may be prepared via any method that makes it possible to obtain a homogeneous mixture containing the composition according to the invention, and optionally other additives, such as melt extrusion, compacting or else a roll mill.

The composition according to the invention is prepared by melt-blending all the ingredients in a “direct” process.

Advantageously, the composition may be obtained in the form of granules by compounding on a device known to those skilled in the art, such as: a twin-screw extruder, co-kneader or internal mixer.

The composition according to the invention obtained by the preparation process described above may then be converted for a subsequent conversion or use known to those skilled in the art using devices such as: an injection-molding press, extruder, etc.

According to one particular mode of implementation of the process according to the invention, the composition may be prepared by melt blending of the components with the exception of the reinforcer, when it is present, that is to say of the polyamide, melamine derivative, optionally polyol and optionally other additives.

This melt blend may be extruded and may then impregnate reinforcing fibers, in order to then be granulated.

According to another mode of implementation, this melt blend may be extruded, granulated, ground in powder form and may then impregnate reinforcing fibers, in order to optionally then be granulated.

The invention thus also relates to an article obtained by injection molding, extrusion, coextrusion, multi-injection molding using at least one composition as defined above.

The process for preparing the composition according to the invention may also use a twin-screw extruder feeding, without intermediate granulation, an injection-molding press or an extruder according to a processing device known to those skilled in the art.

The composition according to the invention may be used for making a structure. This structure may be a monolayer structure when it is formed only from the composition according to the invention. This structure may also be a multilayer structure, when it comprises at least two layers and when at least one of the various layers forming the structure is formed from the composition according to the invention.

The structure, whether it is monolayer or multilayer, may especially be in the form of fibers (for example to form a woven fabric or a nonwoven), a film, a sheet, a tube, a hollow body or an injection-molded part. For example, the films and sheets may be used in fields as varied as the electronics, electrical and avionics fields.

The composition according to the invention may be used for the manufacture of housings, connectors, tubes and parts used in the electrical, electronic and avionics fields.

The composition according to the invention may advantageously be envisaged for the production of all or part of components of electrical and electronic goods, such as encapsulated solenoids, pumps, telephones, computers, monitors, camera remote control units, circuit breakers, electrical cable sheaths, optical fibers, switches, multimedia systems or sandwich panels. It may also be used for the production of all or part of aeronautical equipment such as tubes, tube connectors, pumps, injection-molded parts present in the cockpit or the cabin, such as the walls forming the trim, seat components (back, base, tray). It may also be used for the production of all or part of motor vehicle equipment such as tubes, tube connectors, pumps, injection-molded parts under the engine hood, injection-molded parts such as bumpers, dashboards, and door trim. The motor vehicle equipment components, when they are in the form of tubes and/or connectors, may be used in particular in air-intake devices, cooling devices (for example with air, coolant, etc.), or devices for transporting or transferring fuels or fluids (such as oil, water, refrigerant, in particular the fluid 1234YF (2,3,3,3-tetrafluoropropene)). It may also be used for producing all or part of surgical equipment, packaging, or else sports or leisure articles, such as in bicycle equipment (saddle, pedals). Such components may obviously be made antistatic or conductive, by prior addition of suitable amounts of conductive fillers (such as carbon black, carbon fibers, carbon nanotubes, etc.) to the composition according to the invention.

Other aims and advantages of the present invention will emerge on reading the examples that follow, which are given without any implied limitation.

### EXAMPLES

1/ Formulation of the Compositions

The following compositions A, B and C are prepared:

1.1. Composition A:

PA 11 is prepared according to techniques well known to those skilled in the art by anionic polycondensation of 11-aminoundecanoic acid, without addition of catalyst such as H₃PO₄ during the polycondensation. The following composition A is prepared from the compounds, as defined in table 1 below:

TABLE 1

| % by weight | A |
|---|---|
| PA 11 without | 84 |
| phosphoric acid | |
| Melamine cyanurate | 14 |
| Pentaerythritol | 2 |

The composition is obtained in the form of granules.

1.2. Composition B:

The protocol followed in point 1.1 is also followed for composition B, the compounds of which appear in table 2 below:

TABLE 2

| % by weight | B |
|---|---|
| PA 11 without | 42 |
| phosphoric acid | |
| Melamine cyanurate | 7 |
| Pentaerythritol | 1 |
| Flax fibers | 50 |

1.3. Composition C:

The protocol followed in point 1.1 is also followed for composition C, the compounds of which appear in table 3 below:

TABLE 3

| % by weight | C |
|---|---|
| PA 11 catalyzed with phosphoric | 50 |
| acid + 12% melamine cyanurate, + | |
| 2% pentaerythritol (Rilsan ® MB | |
| 3000 Arkema) | |
| Flax fibers | 50 |

2/ Results

The various compositions were subjected to two flammability tests, a 60 s vertical frame test and a 12 s vertical frame test according to the FAR 25.853-1 standard.

The two 60 sec vertical and 12 sec vertical tests are tests to be carried out for applications respectively for the interior of airliners and for the zones outside of the cabin or business jets in the case of the second test.

The composite compositions, that is to say containing a fiber, in particular a flax fiber, are prepared from granules of the composition (polyamide matrix and additives) or from Rilsan® MB 3000 then ground into powder form. The fibers, in particular flax fibers, are then impregnated with said powders in order to obtain the composite plates.

The results are presented hereinbelow:

FLAMMABILITY Test—60 s Vertical Frame Test

| | after-flame | after-burn length | after-flame |
|---|---|---|---|
| | time (s) | (cm) | time of drips |
| Composition | (criterion 15 s) | (criterion 15.5 cm) | (criterion 3 s) |
| Plates injection | 0 | 6.5 | no flaming |
| molded with | | (average of | drips observed |
| composition A | | 3 values) | |
| Composite plates | 15 | 12.1 | no flaming |
| obtained with | | | drips observed |
| composition B | | | |

FLAMMABILITY Test—12 s Vertical Frame Test

| | after-flame | after-burn | after-flame |
|---|---|---|---|
| Sample | time (s) | length (cm) | time of drips |
| Plates injection | 0 | 0 | no flaming |
| molded with | | | drips observed |
| composition A | | | |
| Composite plates | 3 | 1.5 | no flaming |
| obtained with | | | drips observed |
| composition C | | | |

1. A composition comprising:
at least one polyamide,
at least one melamine derivative as flame retardant,
optionally at least one polyol comprising at least four alcohol functional groups, and
optionally at least one reinforcer in fiber form.

2. The composition as claimed in claim 1, wherein the composition comprises:
at least one polyamide,
at least one melamine derivative as flame retardant, and
at least one polyol comprising at least four alcohol functional groups.

3. The composition as claimed in claim 1, wherein the composition comprises:
at least one polyamide,
at least one melamine derivative as flame retardant, and
at least one reinforcer in fiber form.

4. The composition as claimed in claim 1, wherein the polyamide is selected from the group consisting of PA 6.10 obtained by polycondensation of hexanediamine and decanedioic acid, PA B.12 obtained by polycondensation of bis(3-methyl-4-aminocyclohexyl)methane and dodecanedioic acid, PA 10.12 obtained by polycondensation of decanediamine and dodecanedioic acid, PA 10.10 obtained by polycondensation of decanediamine and decanedioic acid, PA 6.12 obtained by polycondensation of hexanediamine and decanedioic acid, the homopolyamide PA11 obtained by polycondensation of 11-aminoundecanoic acid, the homopolyamide PA12 obtained by polycondensation of 12-aminododecanoic acid or lauryllactam, PA11/6.T, PA11/10.T, PA11/B.10, PA11/6, PA11/6.10, PA11/6.12, PA11/6.6, PA11/10.12 and PA11/B.I/B.T.

5. The composition as claimed in claim 4, wherein the polyamide is selected from the group consisting of PA11, PA12, PA 10.10, PA 10.12, PA 6.10, PA11/10.T and PA11/B.10.

6. The composition as claimed in claim 1, wherein the polyamide has a melt viscosity of between 1 and 500 Pa·s, measured at 240° C. by plate-plate oscillatory rheology.

7. The composition as claimed in claim 1, wherein the composition comprises from 20% to 80% by weight, relative to the total weight of the composition, of at least one polyamide.

8. The composition as claimed in claim 1, wherein the melamine derivative is selected from the group consisting of melamine cyanurate, melamine pyrophosphate and a mixture thereof.

9. The composition as claimed in claim 1, wherein the composition comprises from 5% to 30% by weight, relative to the total weight of the composition, of at least one melamine derivative.

10. The composition as claimed in claim 1, wherein the polyol is selected from the group consisting of erythritol, monopentaerythritol, dipentaerythritol, tripentaerythritol, xylitol, arabitol, mannitol, sorbitol and a mixture thereof.

11. The composition as claimed in claim 1, wherein the composition comprises from 0.5% to 10% by weight, relative to the total weight of the composition, of at least one polyol.

12. The composition as claimed in claim 1, wherein the reinforcer is selected from the group consisting of continuous fibers, long fibers and short fibers.

13. The composition as claimed in claim 1, wherein the reinforcer is selected from the group consisting of natural fibers, polymeric fibers and mineral fibers.

14. The composition as claimed in claim 1, wherein the reinforcer is selected from the group consisting of glass fibers, carbon fibers, flax fibers and mixtures thereof.

15. The composition as claimed in claim 1, wherein the composition comprises from 20% to 80% by weight, relative to the total weight of the composition, of at least one reinforcer.

16. The composition as claimed in claim 1, wherein the composition comprises at least one additive selected from the group consisting of dyes, stabilizers, plasticizers, impact modifiers, surfactants, pigments, optical brighteners, antioxidants, natural waxes, polyolefins, mold-release agents, fillers and mixtures thereof.

17. The composition as claimed in claim 1, wherein the composition is in the form of an injection-molded part, fibers, a powder, a film, a sheet, a tube or a hollow body.

18. A process for preparing the composition in accordance with claim 1, wherein the composition is prepared by melt blending of the at least one polyamide, the at least one melamine derivative, optionally at least one polyol, and optionally at least one reinforcer.

19. A method for manufacturing housings, connectors, tubes and parts used in the electrical, electronic and avionics fields, comprising using the composition as claimed in claim 1.

20. An article obtained by injection molding, extrusion, coextrusion or multi-injection molding using at least one composition as claimed in claim 1.
